(19) United States
(12) Patent Application Publication
(10) Pub. No.: US 2011/0204258 A1
(43) Pub. Date: Aug. 25, 2011

(54) SPECTRAL IMAGING OF PHOTOLUMINESCENT MATERIALS

(76) Inventors: Daniel A. Heller, Cambridge, MA (US); Michael S. Strano, Lexington, MA (US)

(21) Appl. No.: 12/965,394

(22) Filed: Dec. 10, 2010

Related U.S. Application Data
(60) Provisional application No. 61/285,770, filed on Dec. 11, 2009.

(51) Int. Cl. G01N 21/64; B82Y 35/00

(52) U.S. Cl. 250/459.1; 250/458.1; 250/226; 977/750

(57) ABSTRACT

A near infrared imaging and detection system is configured to analyze shifts in photoluminescence of individual nanostructures such as single-walled carbon nanotubes or quantum dots upon binding an analyte. The system can be used to detect, localize, and quantify analytes down to the single-molecule level in a sample and within living cells and can be operated in a multiplex format. The system also can be configured to perform high-throughput chemical analysis of a large number of samples simultaneously. The invention has application in the highly sensitive diagnosis of disease, as well as the detection and quantitative analysis of drugs, molecular pathogens within a living organism, and environmental toxins.

### CROSS-REFERENCE TO RELATED APPLICATION

This application claims the benefit of U.S. Provisional Application No. 61/285,770, filed Dec. 11, 2009, the entire contents of which are incorporated herein by reference.

### STATEMENT REGARDING FEDERALLY SPONSORED RESEARCH

The research leading to this invention was carried out with U.S. Government support provided under Grant No. 6915791 from the National Science Foundation. The U.S. Government has certain rights in the invention.

### BACKGROUND OF THE INVENTION

It has become possible recently to detect and modulate near-infrared fluorophores for use in sensing applications. Solvatochromic shifts, which are wavelength changes due to solvent characteristics, have been known for some time for visible organic dyes. However, only recently have solvatochromic shifts been described for inorganic nanostructures such as near-infrared-emitting carbon nanotubes. The solvatochromic shifts originating from nanomaterials can be tailored to respond to the presence of an analyte, with different species of carbon nanotubes responding uniquely.

Carbon nanotubes fluoresce in the near infrared. Single walled carbon nanotubes (SWNT) fluoresce from 900 to 1600 nm, a region where mammalian tissue and fluids, including whole human blood, are particularly transparent to emission due to good penetration and low auto-fluorescence background. SWNT have a particular advantage as sensing elements because all atoms of the nanotube are surface atoms, making the nanotube especially sensitive to surface adsorption events.

For use in selective optical sensor applications for the detection of analytes, carbon nanotubes must be capable of interacting selectively with the analyte to be detected, and the selective interaction with the analyte must affect carbon nanotube luminescence. Nanotubes in electrical contact with each other may not luminesce if the excited state is depopulated non-irradiatively through inter-tube energy transfer. However, van der Waals interactions provide a large thermodynamic driving force for aggregation of carbon nanotubes. For nanotubes to luminesce, they should be colloidally stabilized to minimize aggregation.

### SUMMARY OF THE INVENTION

The invention provides optical devices, systems, and methods useful for non-perturbing spatial and quantitative analysis of chemical analytes in objects. Preferred embodiments provide spectrally resolved spatial images of biological specimens containing living cells, down to the single molecule level. An imaging system according to the invention is configured to image near infrared photoluminescence properties of carbon nanomaterials and structures, for example, such as single-walled carbon nanotubes (SWNT) or other nanomaterials exhibiting near IR photoluminescence such as quantum dots.

One aspect of the invention is a system for infrared spectroscopic imaging. The system includes a light source, an optical separator, and a detector. In some embodiments the system also includes a microscope. The light source illuminates a region of interest of an object and induces a luminescent emission having a range of infrared wavelengths. The optical separator spatially separates the emission into a first spectral image and a second spectral image. The first spectral image is formed from a shorter wavelength range of light than the second spectral image. The detector is used to detect the first and second spectral images with spatially separated detecting regions of the detecting surface area of the detector. The optical separator can function in several different modes, differing in how the emitted light is separated to form the first and second spectral images. A series of bandpass filters, edge filters, dichroic mirrors, and/or beam splitters is used in the different modes to divide the emission into two, or more, images. In certain embodiments, three, four, or more different spectral images are formed. The system is especially adapted for measuring near IR photoluminescence, including fluorescence, from carbon nanomaterials such as SWNT or quantum dots. The different spectral images are analyzed to reveal solvatochromic shifts or other effects related to the binding of an analyte to carbon nanostructures.

Another aspect of the invention is a method of spectral imaging of a nanostructure. The method includes the steps of illuminating a nanostructure to induce fluorescence emission in an infrared wavelength range, optically separating the fluorescence emission into a first spectral image and a second spectral image, and detecting the first and second spectral images. The first spectral image is formed from a shorter wavelength range than the second spectral image. In some embodiments of the method, the carbon nanostructure is contacted with an analyte, which alters the fluorescence emission of the carbon nanostructure. In some embodiments, the analyte is detected in an object or specimen. Analysis of the fluorescence emission provides information with regard to the presence of the analyte in the object, its location within the object, its concentration within the object, or time-dependent changes in any of these.

A further preferred embodiment employs a plurality of detectors to detect image in different spectral ranges. For example, quantum dots can emit fluorescence in the visible and near infrared portions of the electromagnetic spectrum. A first detector can detect that portion of the image having wavelengths in the infrared range and a second detector, such as a charge coupled device (CCD) or CMOS detector, can detect that portion of the image in the visible portion of the spectrum. One or more light sources can be used depending on the required excitation wavelengths needed for a particular material or group of materials used for a specific application. A preferred embodiment of the invention provides a system and method for the detection and analysis of explosive materials. Preferred embodiments can include system and methods for detecting and characterizing electronic and optical devices.

### BRIEF DESCRIPTION OF THE DRAWINGS

FIGS. 1A and 1B show diagrams representing two embodiments of a microscope system according to the present invention.

FIGS. 2A-2E show a diagram of a microscope according to the invention operated in different modes. FIGS. 2A and 2B show operation in a first embodiment, in which the optical separator uses a dichroic mirror to separate first and second emissions. FIG. 2B provides additional details omitted from FIG. 2A for clarity. FIG. 2C shows operation in a second embodiment, in which the optical separator uses a beam splitter combined with longpass and shortpass filters to separate first and second emissions. FIG. 2D shows operation in a third embodiment, in which the optical separator uses a beam splitter and either two edgepass filters or one bandpass filter for each of a first and second emission. FIG. 2E shows operation in a fourth embodiment, using an arrangement of three beam splitters and appropriate filter sets to provide first, second, third, and fourth emissions.

FIGS. 3A-3C show an embodiment of data analysis for a time-dependent solvatochromic shift observed for SWNT. FIG. 3A shows a split-field image including long wavelength and short wavelength images with two regions of interest (ROI 1 and ROI 2) marked in each image. In FIG. 3B, the time dependence of fluorescence intensity is shown for ROI 1 at both long and short wavelength emissions; analyte was added at 100 s. In FIG. 3C, the traces were fitted using a hidden Markov model to identify single molecule binding transitions.

FIG. 4A shows results of imaging bombolitin II-encapsulated SWNT with different chirality in the presence and absence of an analyte (90 μM RDX, also known as cyclotrimethylenetrinitramine) using the second embodiment. Emission bands corresponding to nine different SWNT species are visible. FIG. 4B shows absorption spectra of several filters employed in operating an embodiment of a microscope according to the invention in the embodiment of FIG. 2C.

FIG. 5A shows photoluminescence spectra of several species of polymer-encapsulated SWNT before and after exposure to an analyte (same SWNT and analyte as in FIG. 4) obtained with a microscope system operating in the embodiment of FIG. 2E. In this embodiment, different filter sets are used to isolate emission bands from four of the SWNT species. FIG. 5B shows a diagram of a corresponding split-field image that can be obtained using the four emission bands indicated in FIG. 5A.

FIG. 6 shows a flow chart summary of a preferred embodiment for a method of detecting an analyte.

FIGS. 7A-7H show the results of an experiment to detect DNA-modifying chemical agents in living 3T3 cells. FIG. 7A shows a fluorescence image of 3T3 cells stained with a lysosomal dye (LysoTracker™, Invitrogen). FIG. 7B shows combined fluorescence of SWNT complexed with DNA together with LysoTracker™. The photoluminescence of SWNT-DNA complexes is shown in FIGS. 7C and 7D, overlayed with a visible image of the 3T3 cells in gray. FIG. 7C shows the cells prior to, and FIG. 7D after addition of H₂O₂. Scale bars in FIGS. 7A-7D are 20 μm. FIGS. 7E-7H show photoluminescence (upper panels) and normalized energy levels as a function of time with the addition of the indicated DNA modifying agents. FIG. 7I shows the results of principal component analysis of the data in FIGS. 7E-7H, with the arrows indicating increasing time.

FIG. 8 shows a diagram of a non-microscopic analyte detection system in accordance with a preferred embodiment of the invention.

FIG. 9 shows a diagram of an analyte surface detection system in accordance with a preferred embodiment of the invention.

FIG. 10A shows the absorption curves of edgepass filters used in a dual-channel microscope measurement.

FIG. 10B is a plot of the normalized intensity of short wavelength and long wavelength channels of 100 averaged nanotube time traces upon addition of 9 μM RDX to surface-adsorbed bombolitin II-bound SWNT;

FIG. 10C is a plot of the averaged normalized time traces of 100 nanotubes without introduction of RDX.

FIG. 10D is a time trace of the intensity of a single nanotube's PL fit by an iterative error maximization.

FIG. 10E is the non-normalized trace corresponding to 10D.

FIGS. 11A and 11B are histograms of step heights of the anti-correlated events in the left, short-wavelength channel (FIG. 11A) and right, long-wavelength channel (FIG. 11B).

FIG. 12 is an optical micrograph of a SWNT fiber.

FIG. 13A illustrates the intensity (top) and wavelength (bottom) responses of bombolitin II-SWNT photoluminescence on exposure to 42 analytes and controls, with nitro group compounds eliciting PL shifting with little concomitant quenching indicated with blue arrows.

FIG. 13B is a table listing the 42 analytes, controls, and concentrations of each analyte used for high-throughput screening, with concentrations listed in μM unless otherwise noted.

FIGS. 14A-B is a plot illustrating the detection and fingerprinting of 13 nitro group compounds by bombolitin II-SWNT, showing the responses of the (7,5) nantube (FIG. 14A) differing from the responses of the (11,3) nanotube to the same compounds.

FIG. 14C is a table listing 13 nitro group-containing analytes, controls, and concentrations of each analyte, with concentrations listed in μM unless otherwise noted.

FIG. 14D is a principal components analysis plot of PL intensity and wavelength responses from 8 (n,m) species of bombolitin II-solubilized SWNT to the 13 nitro group compounds.

### DETAILED DESCRIPTION OF THE INVENTION

This application claims the benefit of U.S. Provisional Application No. 61/285,770, filed Dec. 11, 2009, the entire contents of which is incorporated herein by reference.

The optical systems and methods of the invention can be used in conjunction with nanoscale sensing elements to carry out non-perturbing spatial and quantitative analysis of chemical analytes. Carbon nanostructures or other nanomaterials used as sensing elements can be introduced into an object, even living cells, where their photoluminescence can be monitored, typically in the near infrared wavelength region. Biological polymers or other organic polymers can be added to the carbon nanostructures where they serve as specific analyte sensors. The nanostructure-polymer complexes are subject to solvatochromic effects and other effects that modify their photoluminescence properties, allowing their localization at the single molecule level, and their quantification within specific microenvironments. Imaging systems according to the invention are configured to sensitively image the photoluminescence properties of carbon nanostructures such as single-walled carbon nanotubes (SWNT) in these environments.

The term “analyte” is used herein to refer to any chemical species which is to be detected or the quantity of which is to be determined. Analytes include small molecules, such as sugars (e.g., glucose), steroids, antigens, and polymeric species such as proteins (e.g., enzymes, antibodies, antigens) or nucleic acids (e.g., oligonucleotides, polynucleotides). Analytes are generally one member of a binding partner pair.

Nanomaterials and nanostructures for use with the invention can include carbon nanomaterials such as carbon nanotubes, as well as fragments and derivatives of nanotubes, quantum dots fabricated from semiconductor materials or other types of nanocrystals or nanoparticles. Nanomaterials and nanostructures for use in the invention are defined as having at least one dimension in the nanometer range, i.e., ranging from about 1 nm to about 999 nm, but one or more dimensions (e.g., the length of nanotubes) can be larger. As used herein, “nanoscale” refers to an object having at least one dimension in the range from about 1 nm to about 999 nm. As used herein, “microscale” refers to an object having at least one dimension in the range from about 1 to about 999 μm.

Carbon nanotubes are carbon nanostructures in the form of tubes, ranging in general in diameter from about 0.5 to about 200 nm, and more typically for single-walled carbon nanotubes (SWNT) from about 0.5 to about 5 nm. The aspect ratio, i.e., the ratio of nanotube length to nanotube diameter, is generally greater than 5, preferably ranges from about 10 to about 2000, and more preferably is in the range from about 10 to about 100. Carbon nanotubes can be single-walled or multi-walled, i.e., containing one or more smaller diameter tubes within larger diameter tubes. Carbon nanotubes including SWNT are available from commercial sources, or can be synthesized using discharge, laser vaporization, high pressure carbon monoxide processes, or other processes. There are many published methods for the synthesis of carbon nanotubes, including: U.S. Pat. No. 6,183,714; A. Thess et al. Science (1996) 273:483; C. Journet et al. Nature (1997) 388, 756; P. Nikolaev et al. Chem. Phys. Lett. (1999) 313:91; J. Kong et al. Chem. Phys. Lett. (1998) 292: 567; J. Kong et al. Nature (1998) 395:878; A. Cassell et al. J. Phys. Chem. (1999) 103:6484; H. Dai et al. J. Phys. Chem. (1999) 103:11246; Bronikowski, M. J., et al., J. Vac. Sci. Tech. A, 2001. 19(4): p. 1800-1804; Y. Li et al. (2001) Chem. Mater. 13:1008; N. Franklin and H. Dai (2000) Adv. Mater. (2000) 12:890; A. Cassell et al. J. Am. Chem. Soc. (1999) 121:7975; WO 00/26138; WO 03/084869; and WO 02/16257.

SWNT are sheets of graphene rolled into a molecular cylinder. Their structure can be described by a vector connecting two points on the hexagonal lattice that conceptually forms the tubule with a variable chiral twist. SWNT species are classified according to a chiral vector, designated “(n,m)” which describes the wrapping geometry of the nanotubes. See Weisman, R. B. Nano Letters 3 (2003) 1235-1238. The indices “n” and “m” are integers that denote the number of unit vectors along two directions in the honeycomb crystal lattice of graphene. A species of SWNT designated (n,m) SWNT is formed by connecting one hexagon with another one n units across and m units down. By convention, n>m. The 1-D nature of carbon nanotubes leads to quantization of the circumferential wave-vector, and minor perturbations of the chirality vector can yield large changes in properties. When n=m, the nanotube is metallic in nature. If n−m is a multiple of 3, then the nanotube is semiconducting with a very small curvature-induced band gap. For other values of n and m, the nanotube is semiconducting with a measurable band gap.

Carbon nanotube compositions useful in the invention exhibit optical properties sensitive to the environment of the nanotube. Carbon nanotubes useful in this invention include semiconducting SWNT that exhibit luminescence; preferably they exhibit photo-induced band gap fluorescence, particularly fluorescence in the near-IR. Carbon nanotubes used in the invention are preferably individually dispersed. Preferably carbon nanotube compositions of the invention comprise a substantial amount of semiconducting SWNT, e.g., 25% or more by weight of the total SWNT population. More preferably the carbon nanotubes are 50% or more by weight of semiconducting SWNT. Carbon nanotubes used in the invention may contain a mixture of semiconducting SWNTs of different sizes and different chirality, which exhibit fluorescence at different wavelengths.

Published patent application WO03/050332 describes the preparation of stable carbon nanotube dispersions in liquids, and, published application WO02/095099 describes noncovalent sidewall functionalization of carbon nanotubes. Published application WO02/16257 describes polymer wrapped SWNT. Similarly, quantum dots can be derivatized with ligands so that they exhibit quenching or a shift in photoluminescence upon binding an analyte. See, e.g., Choi J. H. et al., J. Am. Chem. Soc. 128 (2006) 15584-15585. Methods for dispersing SWNT and non-covalently associating them with chemically selective polymers, such as proteins and polysaccharides, are described in U.S. Patent Application Publication 2007/0292896A1. All of these published patent applications are hereby incorporated by reference.

In some embodiments, SWNT or other nanostructures are used within living cells. In order to promote their permeation through membranes of the cell, a low level of surfactant or dispersant, such as those used to disperse SWNT and described in WO03/050332, can be added to the nanostructures prior to their contact with cells. SWNT also can be introduced into cells without surfactants, because their rod-like shape promotes such entry. See, e.g., Lui, Q. et al., Nano Lett. (2009) 9:1007.

In some embodiments, the invention utilizes sensing composition containing a population of SWNT that includes semiconducting SWNT. The population optionally also contains SWNT that are not semiconducting, such as metallic SWNT. In order to serve as analyte sensors, the SWNT or other carbon nanostructures generally will be derivatized by non-covalent association with an analyte sensing moiety, such as a protein, nucleic acid, polysaccharide, or other organic polymer. The sensing composition may further contain amorphous carbon and other byproducts of carbon nanotube or nanostructure synthesis, such as residual catalyst. Preferably, the types and levels of any of these optional components is sufficiently low to minimize detrimental affect on the function of the sensing solution.

Carbon nanotubes are typically produced as poly-disperse samples containing metallic and semi-conducting types, with characteristic distributions of diameters (Bronikowski, M. J., et al., J. Vac. Sci. Tech. A, 2001. 19(4): 1800-1804). Published methods for separating SWNT by diameter and conformation based on electronic and optical properties (e.g., Smalley et al., WO 03/084869) can be used to prepare SWNT having enhanced amounts of certain SWNT species. Narrow (n,m) distributions of SWNT have been obtained using a silica-supported Co—Mo catalyst (S. M. Bachilo, et al., J. Am. Chem. Soc. 125 (2003) 11186-11187). Nanotube separation also can be carried out by anion exchange chromatography of carbon nanotubes wrapped with single-stranded DNA (M. Zheng et al. Science (2003) 302: 1545) the contents of the publication being incorporated herein by reference. Early fractions are enriched in smaller diameter and metallic nanotubes, while later fractions are enriched in larger diameter and semi-conducting nanotubes.

The SWNT or SWNT-polymer complex used for analyte sensing is present in an analyte sensing composition in an amount sufficient to generate a luminescence response of sufficient intensity such that a modulation in that response resulting from the interaction of the analyte with the sensing polymer is detectible. Preferably, the SWNT-sensing polymer complex is provided in an amount sufficient to allow detection of the analyte at a selected lower concentration limit. Preferably the analyte sensing composition does not contain a substantial amounts of carbon nanotubes which are not complexed with sensing polymer. An analyte sensing composition used in the invention preferably does not contain a substantial amount of free analyte-sensing polymer that is not complexed with a carbon nanotube or other carbon nanostructure component of the sensing solution.

Methods, devices and compositions herein are particularly well suited to the detection and quantification of analytes in solutions, such as in biological fluids. Methods, device and compositions herein are also particularly well suited to the detection and quantification of analytes in biological cells and tissues, either living or nonliving. Methods, devices and compositions herein are particularly well suited to the detection and quantification of hazardous materials, including explosive materials.

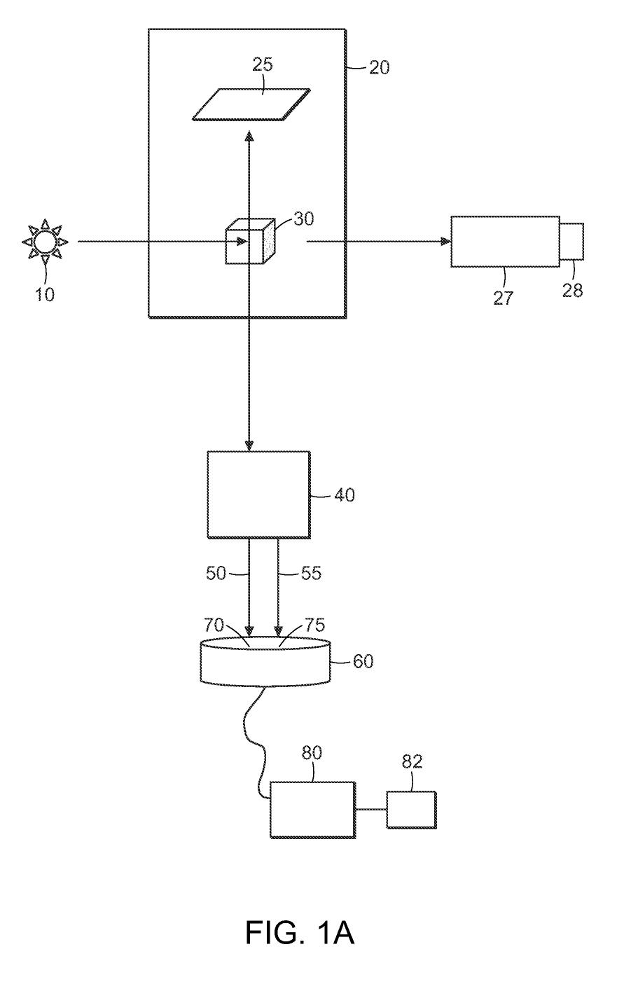

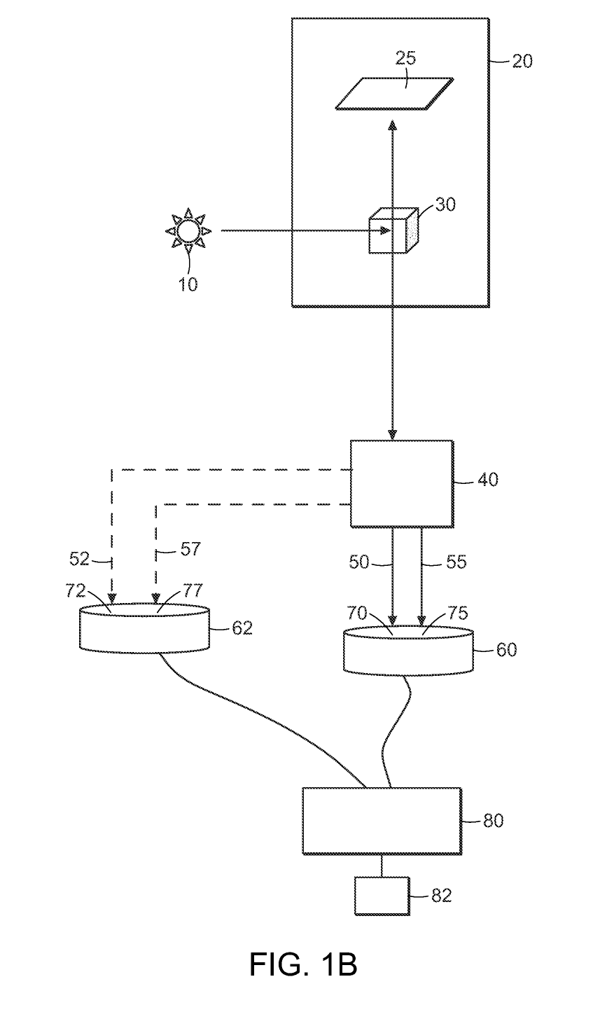

Referring to FIG. 1A, an embodiment of an infrared spectroscopic imaging microscope system according to the invention includes light source 10 coupled into conventional fluorescence microscope 20, containing filter cube 30, which allows an object on the microscope stage to be illuminated, i.e., excited, by a chosen wavelength of light. The filter cube also allows emitted photoluminescence to pass out of the microscope to optical separator 40. The filter cube is fitted with an appropriate set of filters and mirrors to allow excitation light in the wavelength range of at least 400 nm to be reflected onto a region of interest in an object on the specimen stage of the microscope. The filter cube also is fitted with appropriate filters to allow emitted photoluminescence from the region of interest to exit the microscope, usually through a port on the microscope such as a camera port. Light source 10 can be any light source typically used in fluorescence microscopy, including a halogen light source, a laser, or a laser diode, or a combination of different wavelength sources, as determined by the needs of the excitation wavelength range used in a particular application. Optical separator 40 includes a set of mirrors, beamsplitters, and/or filters that divide the light returning from the object in response to the illumination light into two or more images of differing wavelength or spectral ranges. The light output from the optical separator includes at least a first image beam 50 and a second image beam 55, which are directed onto the light sensing surface of detector 60, where a first image 70 and a second image 75 are detected. The first and second images 70 and 75 are each formed on a distinct region of the light detecting surface of detector 60. Detector 60 is preferably a detector, such as a 2D InGaAs focal plane array detector that detects light over a range of wavelengths from 900 nm to 1700 nm, such as those available from Princeton Instruments (e.g., Princeton Instruments Model 2D-OMA V). Such detectors have the capability to register as many as 50 frames per second or more. Preferably, the detector has at least 40,000 pixels of imaging resolution. In a variant of this embodiment, the optical separator produces first, second, third, and fourth spectral images on detector 60, with each image confined to a distinct portion of the light sensitive surface of the detector. Each of the images is formed from a different wavelength band of the light emitted from the region of interest. Image data from detector 60 is passed to a data analysis system, such as a microprocessor or separate computer system, for analysis and storage of the images and data obtained therefrom.

An alternative embodiment is shown in FIG. 1B, in which the optical separator further produces image forming beams 52 and 57, which are used to form third spectral image 72 and fourth spectral image 77 on the light sensing surface of second detector 62. In a preferred embodiment, the optical separator splits the emitted light into further spatially separated image beams, and either or both of the detectors 60 and 62 captures four distinct images, for a total of six or eight spectral images. In another preferred embodiment, each detector can be used to form a single image (i.e., a first and a second image are formed each using a separate detector) of different spectral ranges which can then viewed side by side or overlayed on a display. Regardless of which embodiment is implemented and regardless of the number of images formed, each of the images is formed from a different wavelength band of the light emitted from the region of interest. In a preferred embodiment, the detector can be matched to the spectral region that is being detected. For example, to image portions of the visible spectrum a 2D CCD or CMOS imaging detector array can be used, which detect in spectral ranges of 200 nm to 1100 nm.

In either of the two embodiments shown in FIGS. 1A and 1B, an output signal from detector 60 or 62 is input to data processing unit 80 (e.g., a computer or a microprocessor and memory) having an output on display 82. Further, both of the embodiments shown in FIGS. 1A and 1B can optionally output all or a portion of the light emitted from the region of interest to spectrometer 27, which includes detector 28 capable of detecting infrared light at least over the wavelength range of 900 nm to 1700 nm. The spectrometer can be used to obtain emission spectra over a wider wavelength range including the visible range.

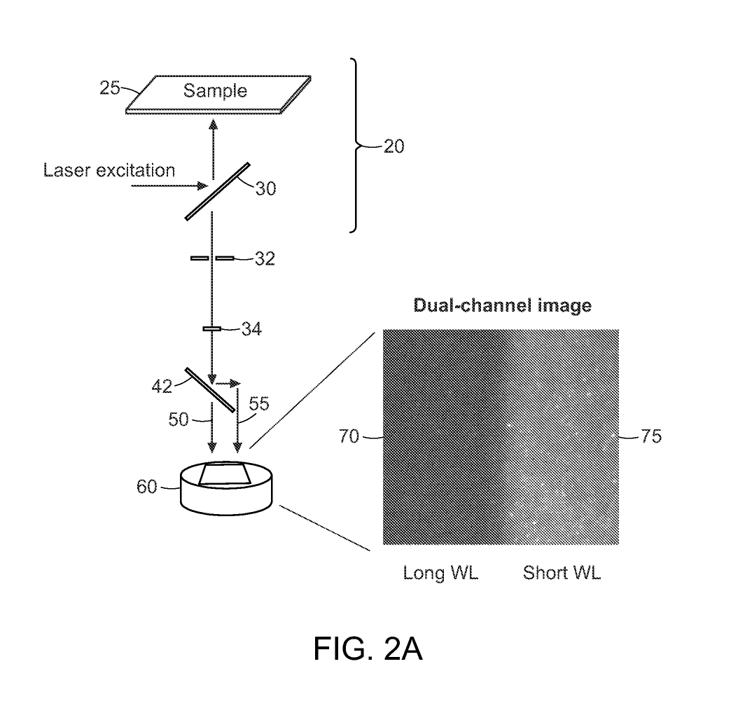

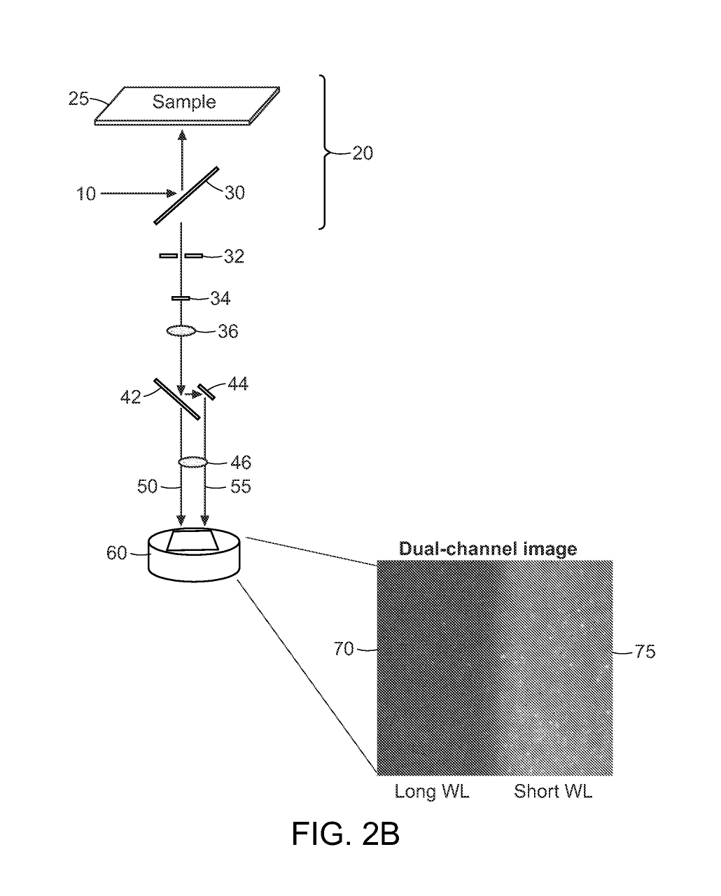

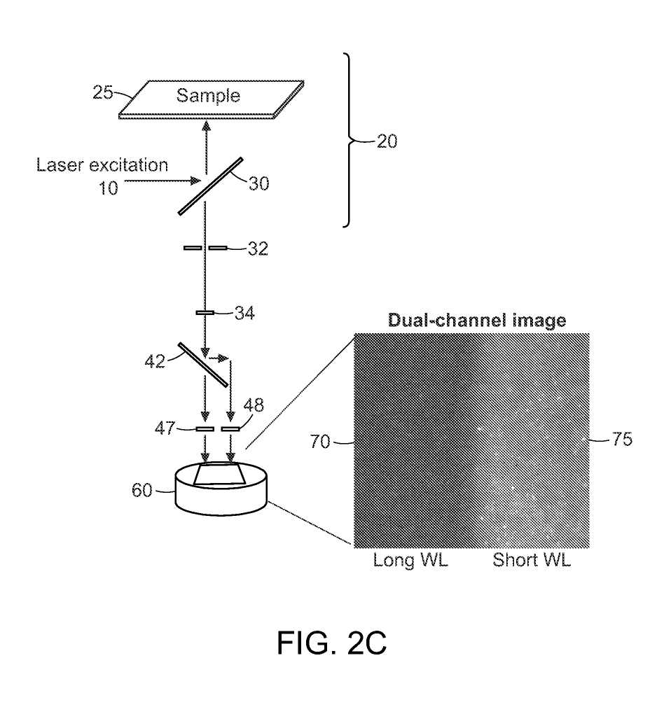

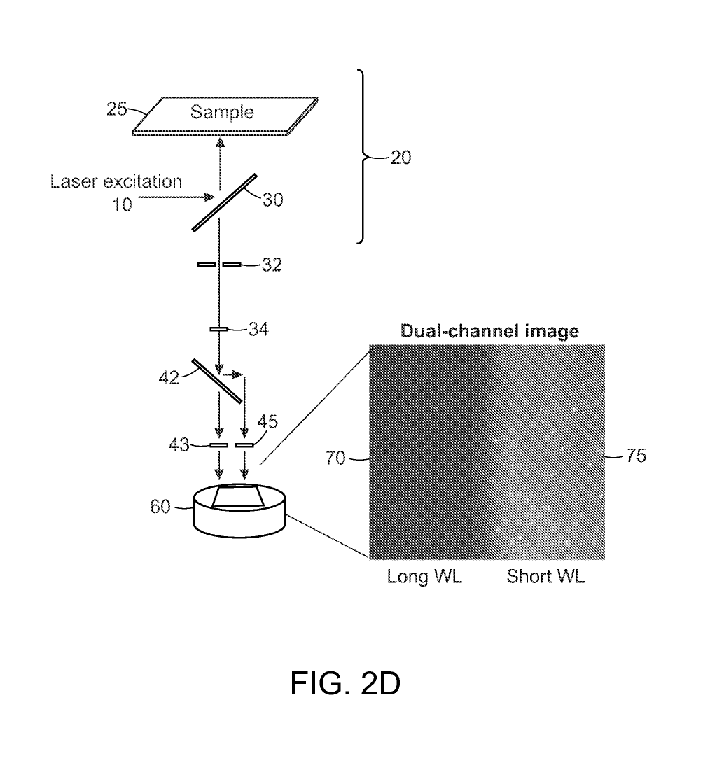

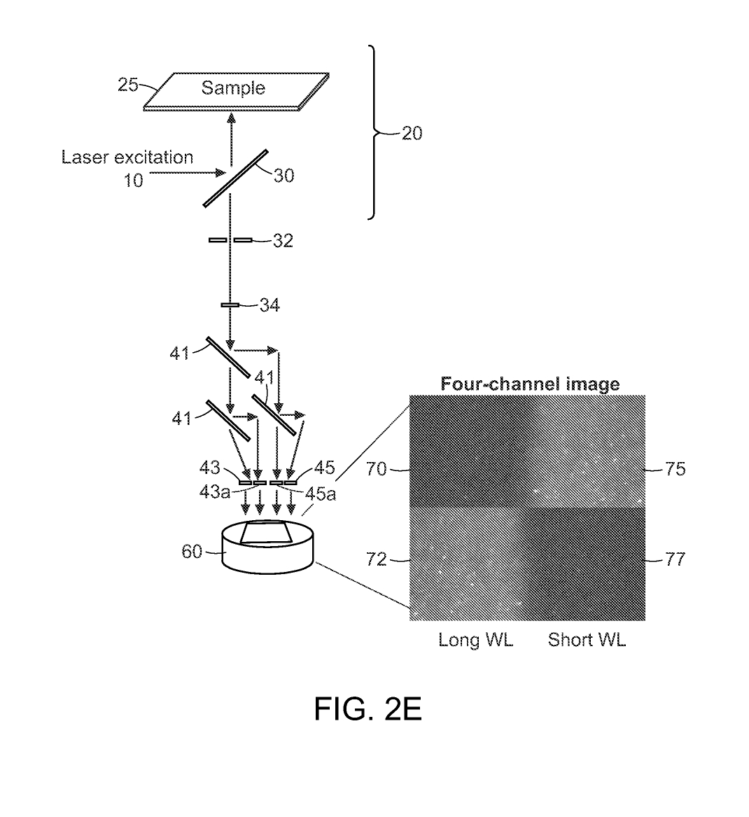

The optical separator 40 is a subsystem for dividing emitted photoluminescence into any desired number of different image forming beams and directing these onto one or more infrared detectors, 60 and optionally 62. The optical separator contains an arrangement of mirrors, beam splitters, and filters to accomplish this. Examples of several possible arrangements are discussed below and shown in FIGS. 2A-2E.

In a first embodiment 1 (FIGS. 2A and 2B), separation into two beams of different wavelength domains in the near IR is accomplished using a dichroic mirror 42 (i.e., dichroic beamsplitter). An example of a suitable dichroic beamsplitter is Chroma Technology Corp. Part No. zt980rdc-xt. Light emission transmitted from the microscope's filter cube 30 is passed through optical slit 32 (e.g., a 5 mm slit) at the focal plane. In addition, a bandpass filter 34, or alternatively two edge filters 34, can be used to isolate the total bandwidth of the near IR spectrum of interest for forming the first and second images (70 and 75 respectively). Lens 36 (e.g., a near-IR achromatic lens, 50 mm diameter, 150 mm focal length) is used to converge the beam prior to splitting the beam with dichroic mirror 42. The dichroic mirror creates two beams, first emission 50 and second emission 55, each having a different wavelength band of the near-IR light isolated by filter 34. Light reflected by the dichroic mirror can be directed onto flat mirror 44 and reflected towards detector 60. Both long and short wavelength bands are converged onto detector 60 by means of lens 46 (e.g., a near-IR achromatic lens, 50 mm diameter, 150 mm focal length). Generally, one of the images (e.g., the first image) contains light from the longer wavelength portion of the total isolated bandwidth, and the other image (e.g., the second image) contains the remaining light from the total isolated bandwidth, which forms the shorter wavelength portion.

In a second embodiment 2 (FIG. 2C) the separation is accomplished using either a dichroic mirror 42 or a beam splitter 42 (preferably a 50/50 beamsplitter, such as Chroma Technology Corp. Part No. 50/50bs-ir, RT 800-1400 nm) in conjunction with two different filters, one longpass filter 47 to isolate the longer wavelength portion of the total isolated bandwidth and one shortpass filter 48 to isolate the shorter wavelength portion. Filters can be angled relative to the incident beam to adjust the cut-on or cut-off wavelengths. An example of an appropriate filter set is Omega Optical Part No. 1030AELP (longpass filter with 1030 nm cuton) and Omega Optical Part No. 1030ASP (shortpass filter with 1030 nm cutoff). Note that certain optical components, such as lenses, have been omitted from certain figures for clarity.

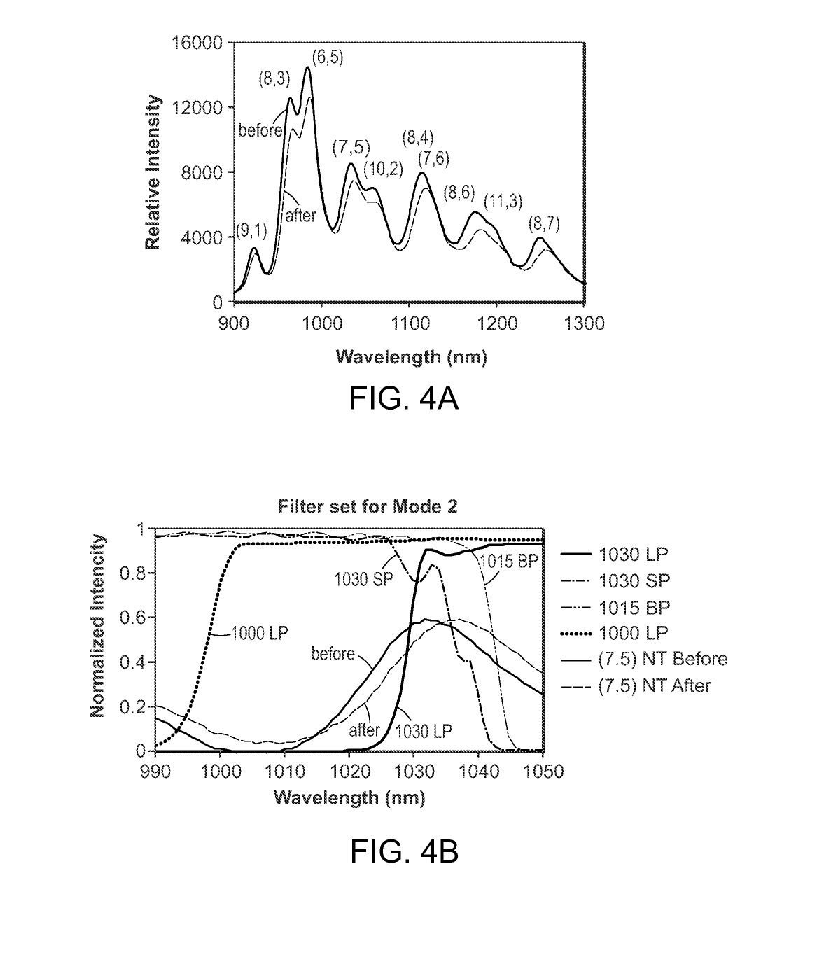

An example of operation of the system shown in FIG. 2C is shown in FIGS. 4A and 4B. FIG. 4A shows photoluminescence spectra of polymer-encapsulated SWNT (encapsulated with bombolitin II peptide) before and after exposure to 90 μM RDX as analyte. Excitation was carried out at 785 nm with a laser (Ocean Optics Part No. Laser 785, a filter coupled 785 nm laser for Raman spectroscopy). An emission spectrum for the image is presented in FIG. 4A. Nine different peaks are shown, each corresponding to a different species of SWNT. The chiral vector of the different SWNT species are indicated in the figure. FIG. 4B shows the absorption spectra for filters used in an optical separator designed to isolate the (7,5) SWNT emission peak. The emission peak of (7,5) SWNT is also displayed for the absence and presence of an analyte (RDX).

In a third embodiment (FIG. 2D), separation of emitted wavelength domains is accomplished using beamsplitter 42, preferably a 50/50 beamsplitter, in conjunction with two different filter sets, filter set 43 for the long wavelength band and filter set 45 for the short wavelength band. Each of the filter sets includes either a single bandpass filter or a combination of two edgepass filters to define the isolated bandwidth. For example, the bandpass filter Chroma Technology Corp., Part No. 975/50, centered at 975 nm with 50 nm bandwidth, can be used.

The operation of a fourth embodiment is depicted in FIG. 2E. This embodiment provides four or more different spectral images, each representing a different wavelength band of emitted light. The emitted light is divided into four beams by an appropriate combination of beamsplitters 41 (preferably 50/50 beamsplitters), together with four different filter sets, one for each wavelength band. Filter set 43 isolates the first long wavelength band, filter set 43a isolates the second long wavelength band, filter set 45 isolates the first short wavelength band, and filter set 45a isolates the second short wavelength band. This arrangement produces additional distinct spectral bands compared with embodiments 1-3, which can be useful in a multiplex assay format where multiple distinct nanostructures are examined simultaneously, each corresponding to a different emission band.

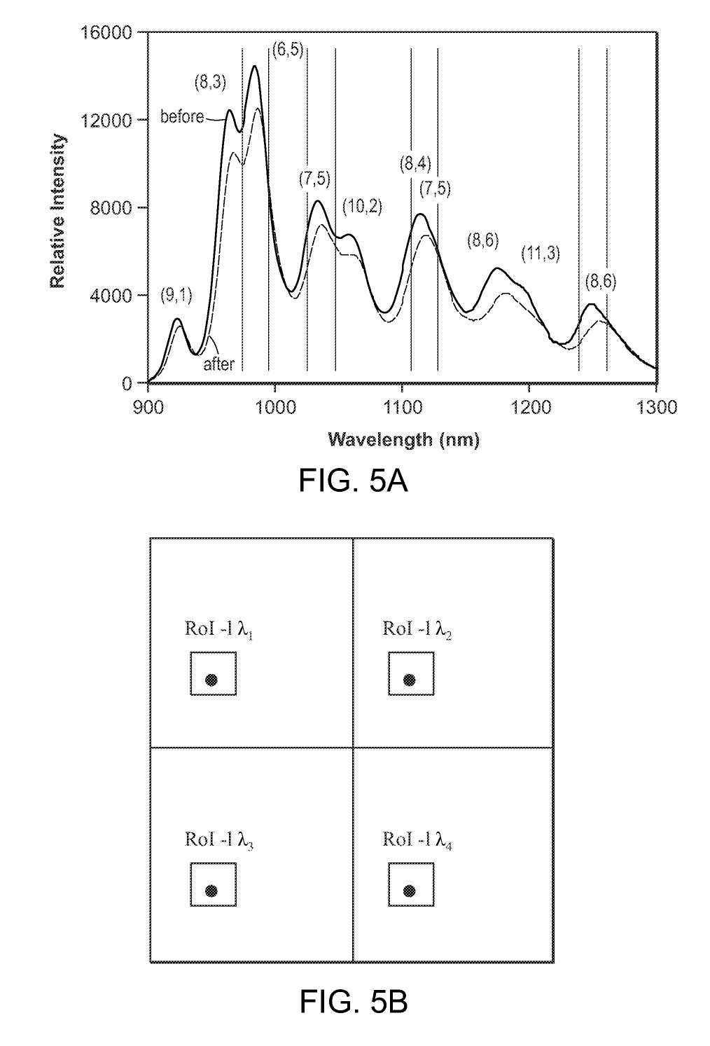

FIGS. 5A and 5B demonstrate the use of the embodiment of FIG. 2E to simultaneously isolate four different species of SWNT (encapsulated with bombolitin II peptide) located within the same area of interest. Emission spectra are shown for polymer-encapsulated SWNT before and after the introduction of an analyte (RDX). A laser with 785 nm was used to excite the SWNT. FIG. 5B shows images corresponding to four different SWNT analyzed simultaneously. Each of the spectral ranges λ₁-λ₄ can have one or more regions of interest (ROI) identified and selected by the user for further quantitative analysis such as the determination of the concentration of a particular analyte within the wavelength range of interest in the selected ROI.

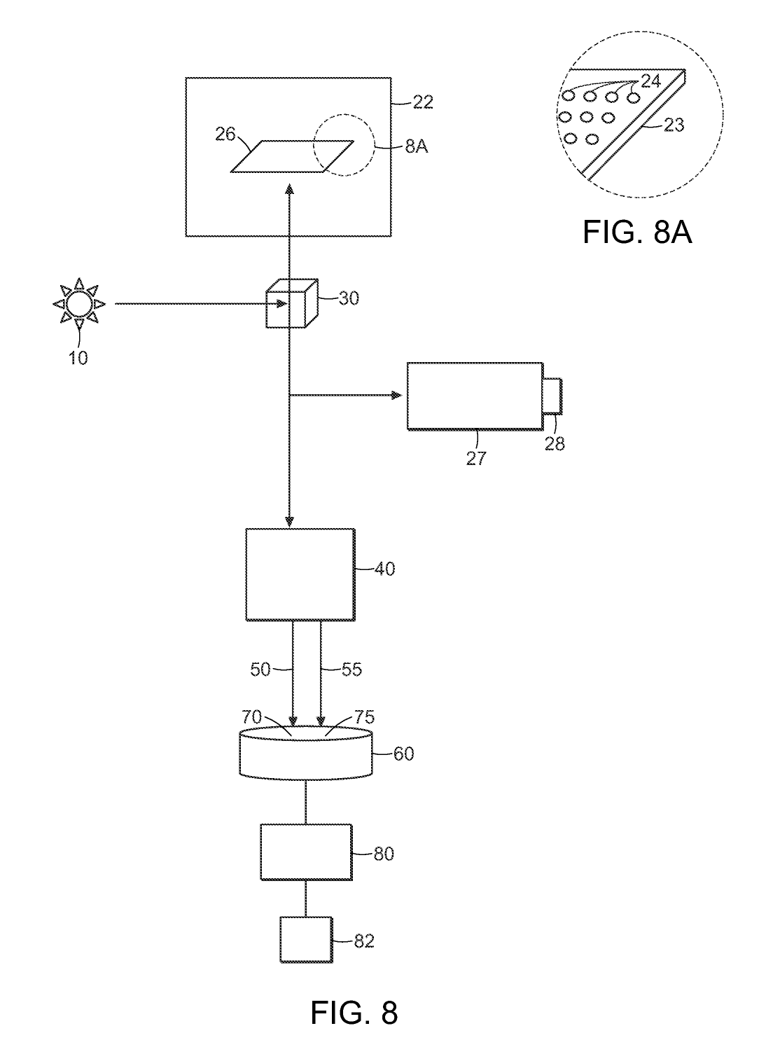

FIG. 8 depicts an analyte detection system that does not include a microscope. In this embodiment, an analyte from a sample is added to the detection system to be detected and/or quantified, and the imaging capability of the system can be used to convey positional information for simultaneous analysis of a plurality of samples, e.g., using an array. The system includes analyte detection device 22, containing analyte detection chamber 26. The analyte detection chamber contains one or more regions or wells 24 each containing one or more carbon nanostructures, such as SWNT or quantum dots, arranged on substrate 23. The nanostructures are preferably attached to the substrate through covalent or non-covalent bonds, so that the nanostructures remain stably attached to their assigned position during the analysis of an analyte, such as during solution exchange or washing steps. The other components of the analyte detection system are similar to those of the microscope systems shown in FIGS. 1A and 1B and described above. The regions or wells used for analyte analysis are preferably arranged in an array pattern and their size can be nanoscale, microscale, or larger. Any desired number of wells can be present in such an array. For example, the array can contain two or more wells, 96 wells (such as a microliter plate), or larger numbers of wells, such as about 400, 1000, 10000 or more. The carbon nanostructures can be attached to the bottom of the wells, or can be attached to other structures that can be added to and removed from the wells, such as beads, fibers, or particles of any suitable material (e.g., glass, ceramic, or a synthetic or biological polymer). Furthermore, analyte detection chamber 26 can contain microfluidics reaction chambers, mixing chambers, fluid passages, reagent reservoirs, optical detection windows, valves, and the like as required to implement the analysis on a microscale or nanoscale, or in a “lab-on-a-chip” format.

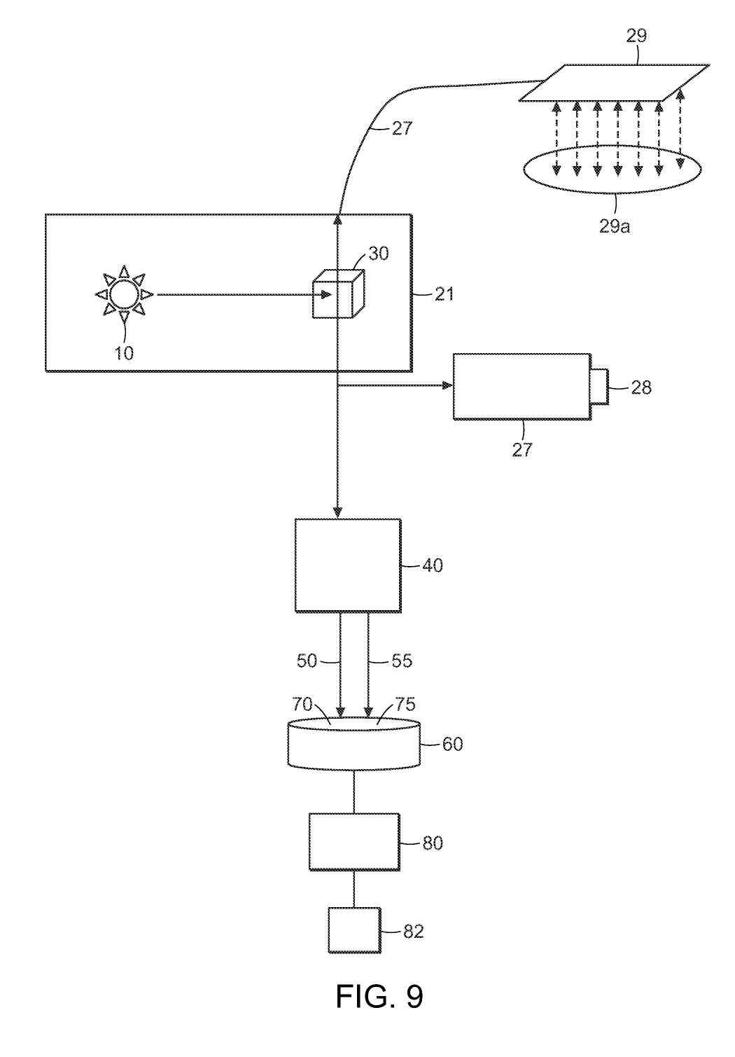

FIG. 9 depicts a surface analysis system for analysis of analytes attached to or embedded within a surface. This embodiment can be used, for example, to detect an analyte on an object's surface or within a surface layer, such as the skin of an animal or human, or plant material, of a wipe taken from an environmental surface. Sample surface 29a can be analyzed by illumination and detection using movable optical head 29 which is placed adjacent to the surface to be analyzed. The surface is prepared for analysis by adding to the surface a liquid, cream, or paste containing suitable carbon nanostructures that can bind the desired analyte or analytes found on the surface or within a surface layer accessible to the nanostructures by diffusion. The optical head is optically coupled through fiber optic connection 27 to light source and distribution unit 21. The remaining components are similar to the microscope system shown in FIGS. 1A and 1B and described above.

In an embodiment capable of measuring photoluminescence in both the near infrared and visible range, a microscope or non-microscopic analytical device can be outfitted in any of the above described modes with both a near infrared detector and a visible light detector. The near infrared detector is preferably of the InGaAs type (e.g., Princeton Instruments Model 2D-OMA V), while the visible light detector can be, e.g., a CCD camera. Each of the detectors preferably has at least 40,000 pixel resolution. This embodiment is capable of simultaneously analyzing photoluminescence from nanomaterials emitting over the entire visible to near IR range, such as from about 400 nm to about 1700 nm. With this embodiment, visible light emitting nanomaterials, such as quantum dots, can be combined in the same optical field with near IR emitting nanomaterials, such as SWNT. In addition, a plurality of nanomaterials such as quantum dots having emissions distributed over the full visible and near IR wavelength range, or any portion thereof, can be detected and quantified simultaneously. Thus, multiple species of analyte, e.g., 2, 4, 8, 10, 12, 15, 16, or 20 or more can be measured in a multiplex assay. Because the output of the two detectors is scaled differently, a standardization procedure can be carried out for a given detector combination in order to provide continuous output over the spectral ranges of both detectors. For example, a series of standards having different emission wavelengths can be measured and used to make a conversion curve that can be used to adjust for the difference in optical efficiency between the two detectors.

The invention includes methods that utilize any of the optical detection systems described above to detect, localize, and/or quantify an analyte in an object, including a sample from a patient or a part of a patient's body. In one embodiment, the skin of a mammalian body can be illuminated with light to induce autofluorescence of the skin for diagnostic imaging of the tissue.

The methods involve detecting photoluminescence from a carbon nanostructure introduced into object, such as a cell, or placed onto a surface of the object, or attached to an assay chamber, such as a well in a microarray. The method is extremely sensitive to changes in photoluminescence that can be assigned to single molecules, or a plurality of molecules, interacting with one or more nanostructures, such as a SWNT. For optimum specificity, a nanostructure is used that has been coated, at least in part, with a polymer, such as a biological polymer, i.e., a protein, an antibody, a polysaccharide, a nucleic acid, or a synthetic polymer, which provides binding specificity for the desired analyte.

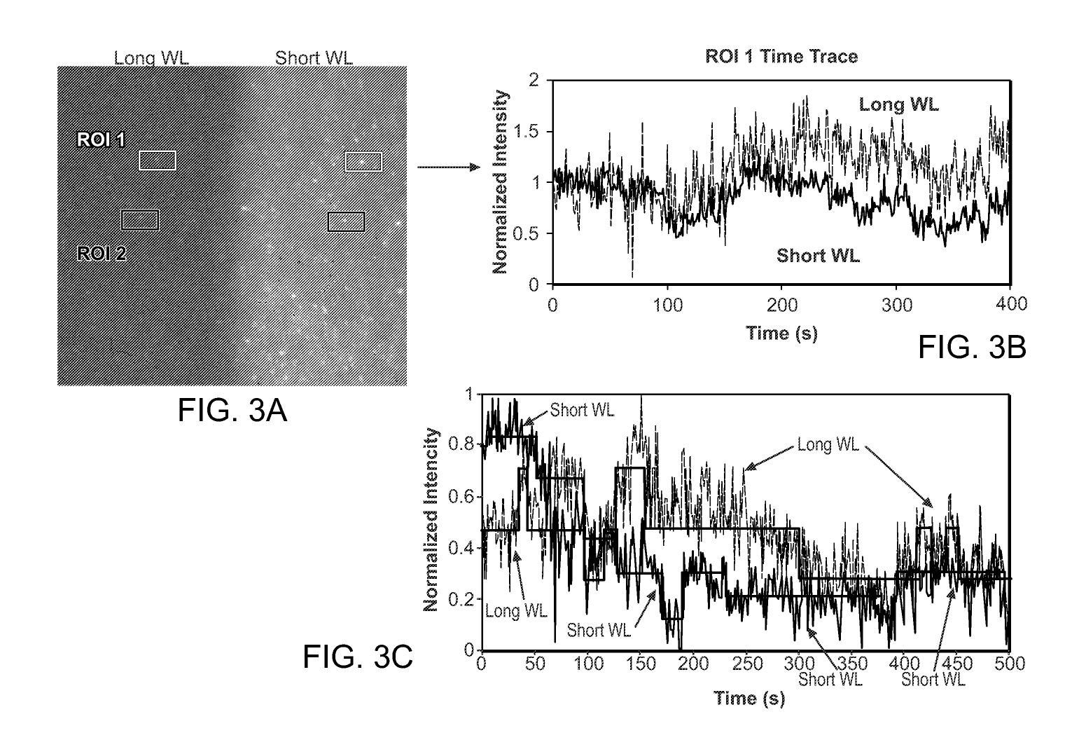

FIGS. 3A-3B show time dependent photoluminescence changes observed during a movie in which an individual SWNT (e.g., ROI 1 or ROI 2, SWNT encapsulated with bombolitin II peptide) of a given type is monitored. The microscope system was operated in Mode 2. As analyte, 90 micromolar RDX (cyclotrimethylenetrianitramine, a ligand that binds to bombolitin II) was added. The data were normalized to the initial time point. A video image sequence of bombolitin II encapsulated SWNT was acquired using camera acquisition software at least 1 frame per second (or more). Light from regions of interest (ROIs) in both channels was acquired (see FIG. 3A). The short wavelength band was 1000-1030 nm and the long wavelength band was 1030-1100 nm. The image field in both channels was the same; i.e., the same area was selected in both channels. The intensity of both long and short wavelength regions was averaged (alternatively they can be summed) and are plotted versus time in FIG. 3B for the ROI 1 region indicated in FIG. 3A. As the analyte binds to the encapsulated SWNT, the photoluminescence intensity in the long wavelength channel increases while that in the short wavelength channel decreases. The long wavelength (WL) emission increased while the short wavelength emission decreased, signifying a red-shift of the emission wavelength of the nanotube in the ROI.

Often, single molecule binding events can be detected as stochastic changes in intensity over time. See for example, Heller et al., Nature Nanotech. 4 (2009) 114-120, which is incorporated herein by reference. An analysis of this type of measurement is demonstrated in FIG. 3C. A video recording was acquired by the microscope in the embodiment of FIG. 2C using the bombolitin II encapsulated SWNT. 90 micromolar RDX was added at 100 seconds of the movie, which was acquired at 1 frame/s. In this example, two filters (one longpass filter and one shortpass filter) were used to split the nanotube emission peak at 1030 nm. Two 2×2 pixel ROIs were drawn to encompass the same individual nanotube emission spot in both channels. The ROIs were drawn and the numerical intensities of the 2×2 pixel spots over the entire span of the video image sequence were obtained using the Time Series Analyzer plugin in the ImageJ software such as that available at www.Macbiophotonics.ca/ImageJ. The time traces were normalized and fitted by a Hidden Markov Model using a method described in the literature. See Jin H. et al., Nano Letters 8 (2008) 4299-4304; McKinney, S. A. et al., Biophys. J. (2006), 91:1941-1951; and Joo, C. et al., Cell (2006), 126:515-527 the entire contents of these references being incorporated herein. The photoluminescence intensities in the long wavelength channel and the short wavelength channel are shown in FIG. 3C. Single-step quenching and wavelength shifting events are visible in the traces. The fitted curves shown in FIG. 3C indicate single-molecule analyte binding and dissociation events. A binding event occurs when the fitted long wavelength emission increases and the fitted short wavelength emission decreases, and dissociation occurs when the opposite is observed.

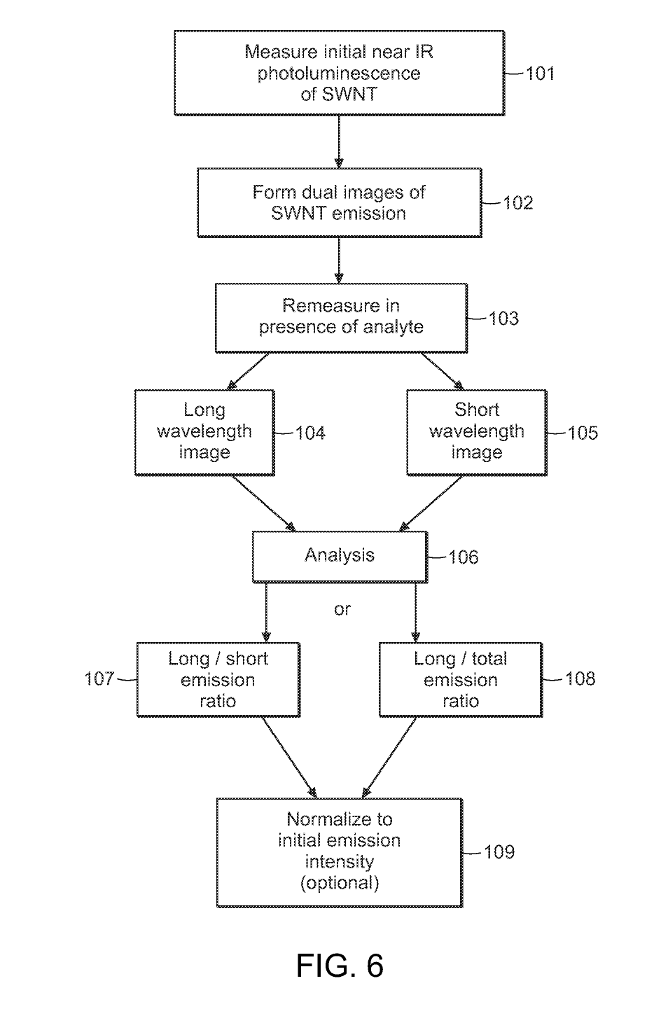

In FIG. 6 a flow chart is presented that shows one embodiment of an analyte detection assay. An initial near IR photoluminescence of a polymer-coated SWNT is measured 101, following which first and second spectral images are formed 102. After an analyte is added to the composition containing the SWNT, the photoluminescence is remeasured 103 under the same conditions as before, producing long wavelength 104 and short wavelength 105 images. For each condition (before and after analyte, or at different analyte concentrations), the emission data are analyzed 106. Two possible analysis modes are indicated for determining analyte concentration. In one 107, the ratio of the long wavelength channel intensity/short channel intensity wavelength channel intensity is determined. In the other 108, the ratio of the long wavelength intensity/total intensity for both channels is determined. In either case, the data are optionally normalized 109 to the initial intensity so as to improve the accuracy of the comparison of different analyte conditions. In the case of quantitative analysis using different detectors it is necessary to normalize the analysis of the first detector to that of the second detector.

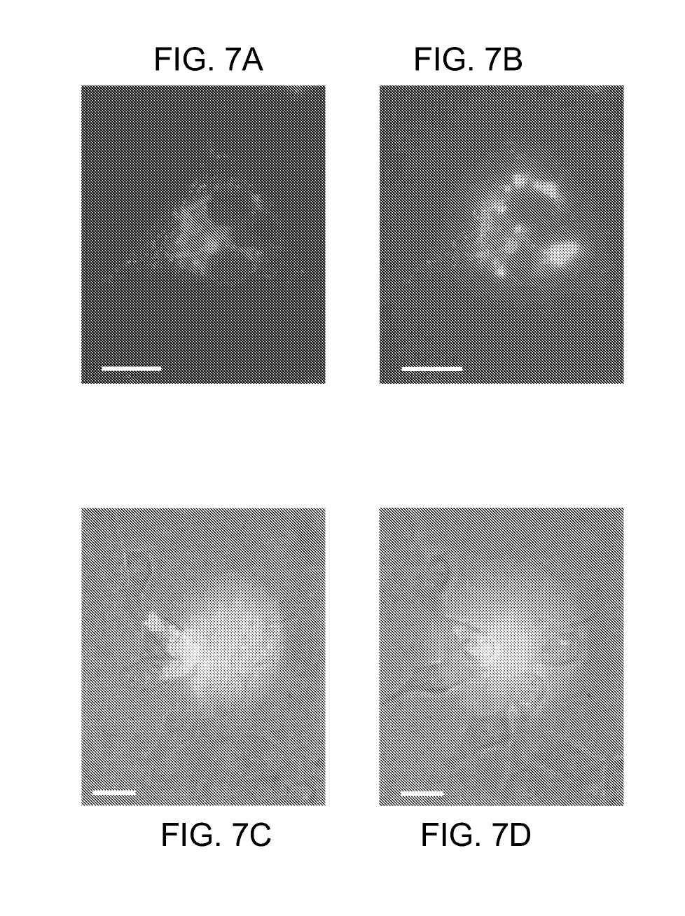

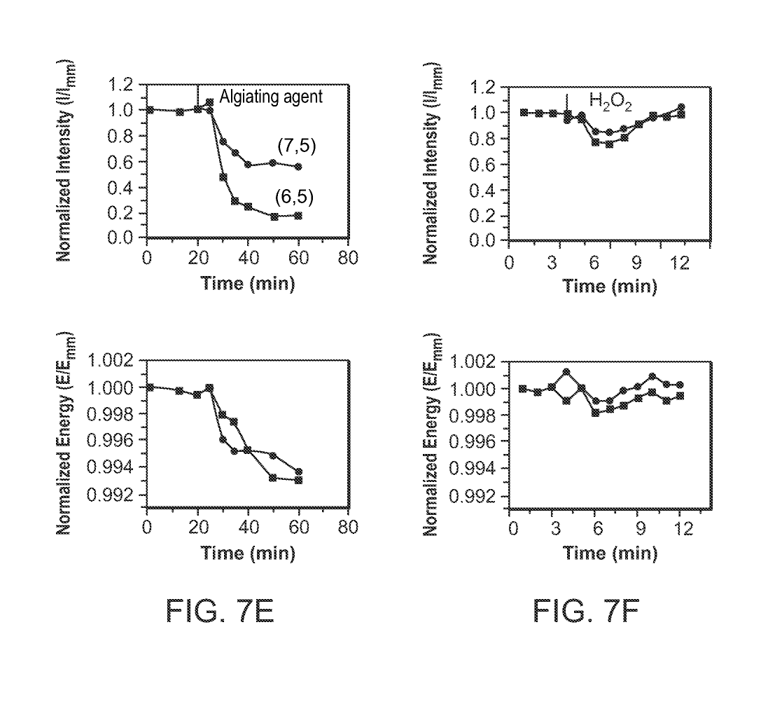

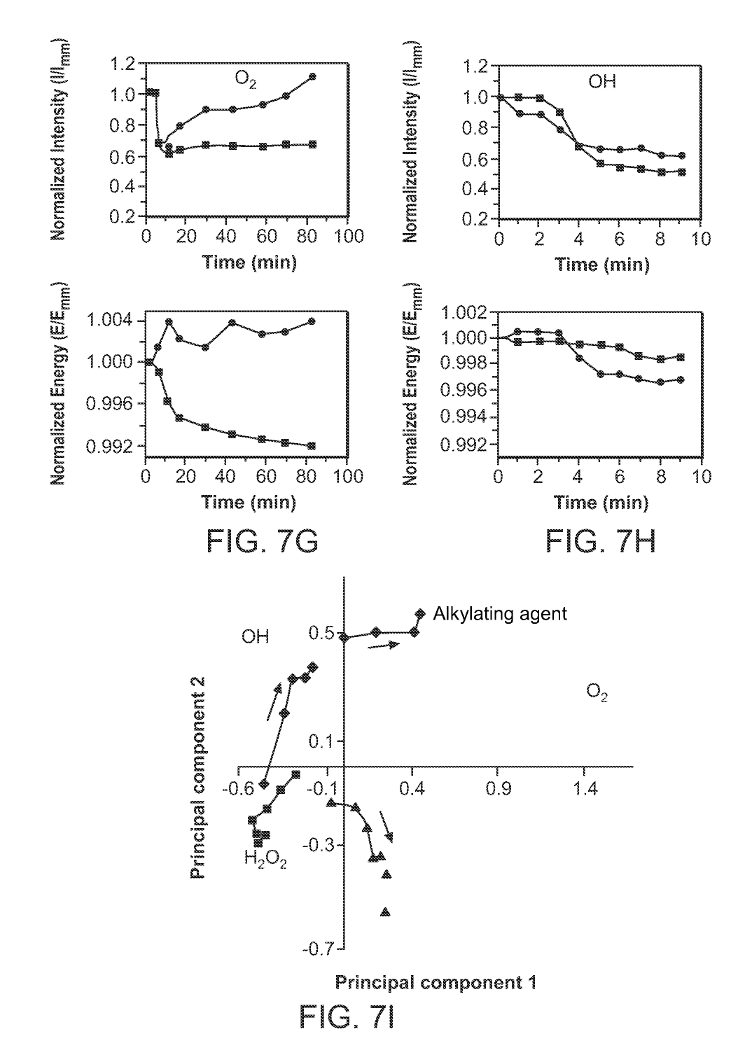

FIG. 7 shows the results of an experiment in which 3T3 cell were loaded with SWNT coated with oligodeoxyribonucleotides. See Heller et al., Nature Nanotech. 4 (2009) 114-120 previously incorporated herein by reference. The cells were treated with different genotoxic chemicals (analytes) as indicated. The results demonstrate that the photoluminescence intensity changes of SWNT-DNA complexes interacting with genotoxic agents can be spatially resolved within single cells.

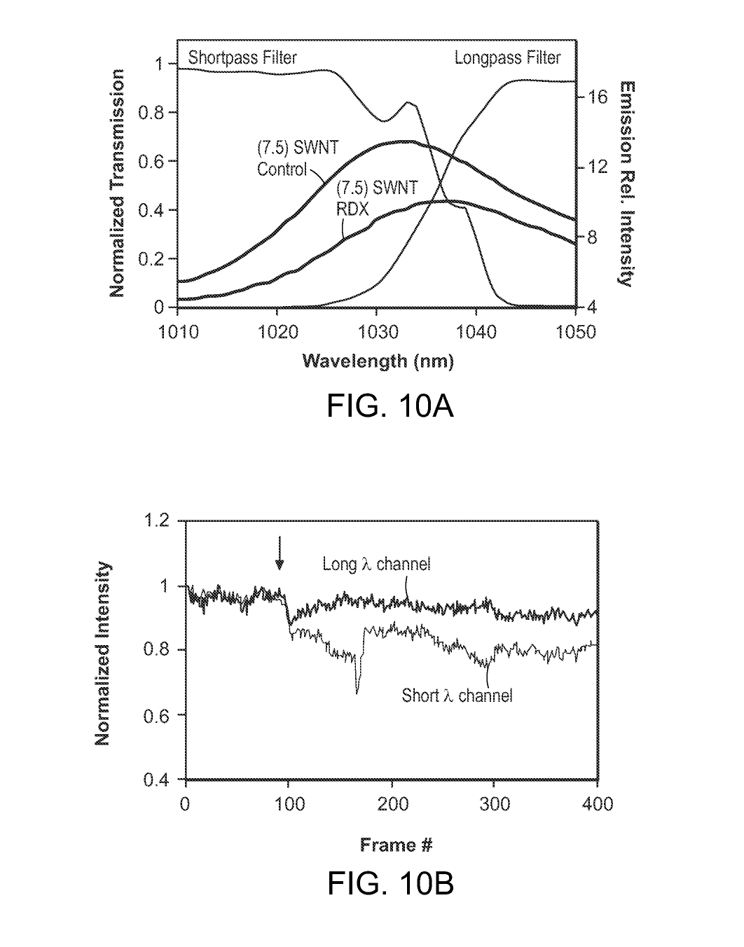

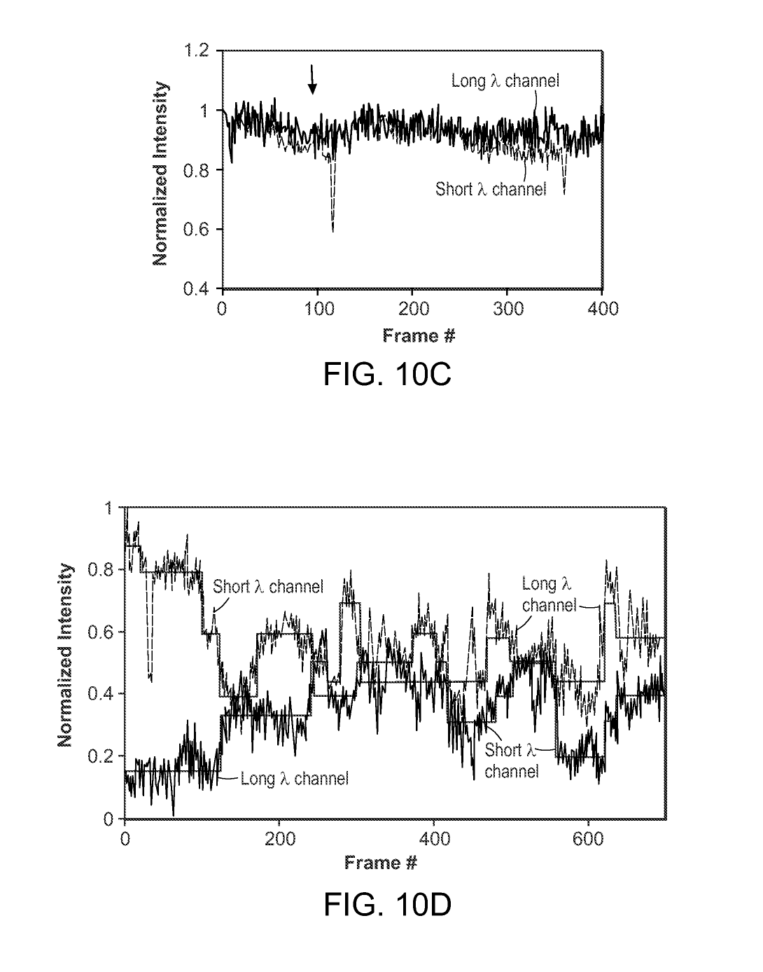

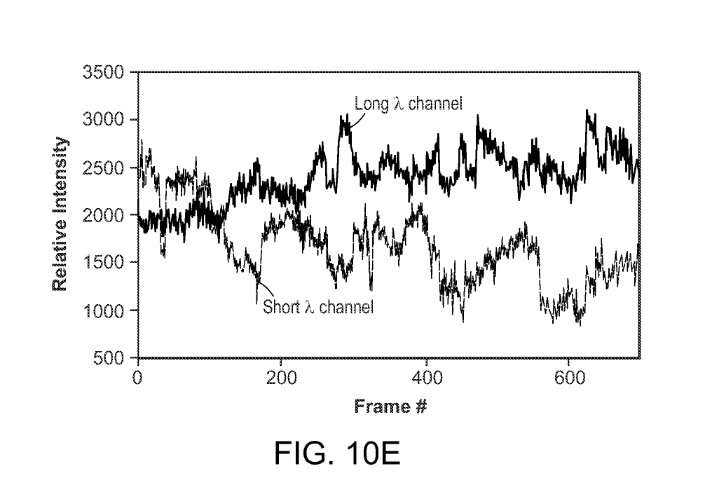

FIGS. 10A-10E illustrate single-molecule detection using a split-channel microscope of the present invention. FIG. 10A shows the absorption curves of edgepass filters used in the dual-channel microscope measurements, plotted with the (7,5) SWNT PL curves before (“control”) and after (“RDX”) introduction of 90 μM RDX. FIG. 10B shows the normalized intensity of short wavelength and long wavelength channels of 100 averaged nanotube time traces upon addition of 9 μM RDX to surface-adsorbed bombolitin II-bound SWNT, with FIG. 10C showing the averaged normalized time traces of 100 nanotubes without introduction of RDX. The simultaneous anti-correlated behavior of the split-channel nanotube emission after RDX addition demonstrates the effect of solvatochromic shifting of individual, surface-adsorbed SWNT by RDX. FIG. 10D shows the time trace of the intensity of a single nanotube's PL fit by an iterative error maximization. The addition of 9 μM RDX occurred at time=100 seconds (indicated by arrow). The corresponding non-normalized trace is shown in FIG. 10E.

In this measurement, as-produced bombolitin II-SWNT were deposited on a glass-bottom petri dish (MatTek Corporation) for 15-30 minutes, rinsed 3× with Tris buffer, and left with 100 μL Tris buffer covering the glass-bound nanotubes. The imaging buffer included an aliquot of 8 μM of bombolitin II peptide. Movies were collected at 1 second/frame. An aliquot of 100 μL of 18 RDX suspended in Tris buffer was added to the Petri dish 100 seconds after data collection began, resulting in a final concentration of 9 μM. The path was modified by the optical setup illustrated in FIG. 2C. Spots of 2×2 pixels on the two channels were correlated by translating the ROI by a constant x value. Intensity time-trace information of the top 100 highest-intensity spots on the short WL channel, along with their long WL channel complements, was collected.

In accordance with one embodiment of a data fitting and histogram generation method, the time-traces were fit to an iterative error-minimizing step-finding algorithm described by Kerssemakers J W J, et al. (2006), “Assembly dynamics of microtubules at molecular resolution,” Nature 442(7103):709-712 (in English), the entire contents of which is incorporated herein by reference.

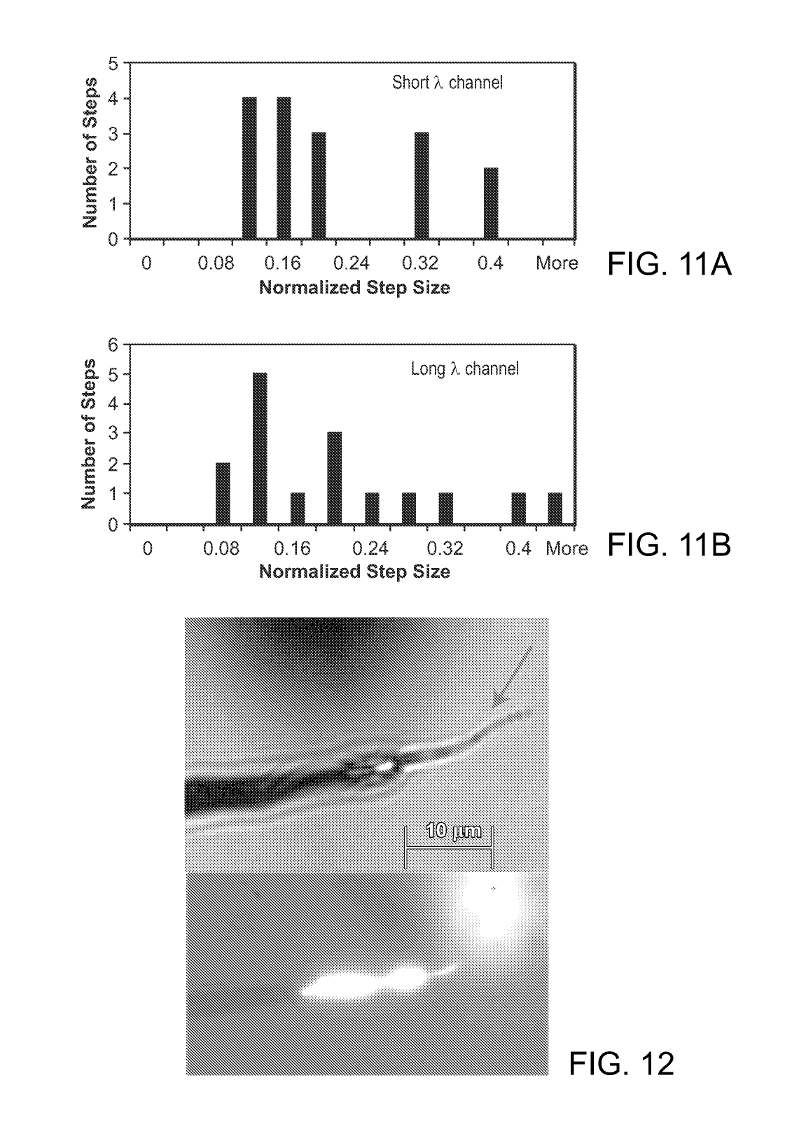

Fitted traces of the long and the short wavelength channels are compared to determine the correlation of single-step events. In a preferred embodiment, the fittings (not the original traces) are compared using a simple algorithm to determine whether a step occurred in both traces simultaneously. For example, events the short wavelength and long wavelength channels are determined to be corresponding if they fell within ±1 frames of each other. Both correlated (the step in both channels moving in the same direction—up or down) and anti-correlated (the steps move in opposite directions) events are recorded. Histograms of step heights of the anti-correlated events in the left, short-wavelength channel (FIG. 11A) and right, long-wavelength channel (FIG. 11B) are shown. The data shows quantization at several step heights, instead of a Gaussian or Poisson distribution, suggesting that discrete step-wise events are occurring and that single steps are preferred over two or three simultaneous steps (denoted by integer multiples of the smallest step size). The results indicate that single-molecule binding events can be obtained by this technique.

FIG. 12 is an optical micrograph of a SWNT fiber. The upper panel shows an optical image of the fiber supported on a tungsten tip, and the lower panel shows the corresponding two-dimensional near-infrared InGaAs photoluminescence image (with 658-nm-wavelength laser excitation, 1 mW, 1 s exposure), showing bright photoluminescence from the very end of the fiver in a solid state, confirming a high degree of semiconductor purity. Note that the light emission at the upper-right corner is due to a halogen lamp source. Examples of SWNT-based filaments or fibers and various applications therefor are described by Han et al. (2010), “Exciton antennas and concentrators from core-shell and corrugated carbon nanotube filaments of homogeneous composition,” Nature Materials 7, 833-839, the entire contents of which is incorporated herein by reference.

In certain embodiments, the present invention includes the selective optical detection of binding events by single-SWNT PL modulation, employing both intensity and wavelength-based signal transduction. Specific non-covalently bound polymers can be harnessed to change the properties of the nanotube-polymer complex, resulting in complete modulation of the nanotube sensitivity to certain analytes. Resolution of an entire class of molecules can be achieved by the nanotube via reporting the conformational state of a peptide. Nanotube emission undergoes solvatochromic shifts due to nitroaromatic compound-mediated secondary structure changes of the amphipathic bombolitin II oligopeptide. Solvatochromic interactions are probed at the single-nanotube level by a novel strategy in which two spectrally-adjacent optical channels measure anti-correlated, quantized fluctuations, signifying molecular binding events. In addition, it has been found that the ss(AT)₁₅ oligonucleotide imparts optical selectivity of SWNT for trinitrotoluene (TNT) via intensity modulation. Although nanotubes do not normally detect this analyte, the electronic and steric effects of this encapsulating sequence allow single-molecule detection by reversible excitonic quenching. Forward and reverse rate constants can be fit using the birth-and-death population modeling approach.

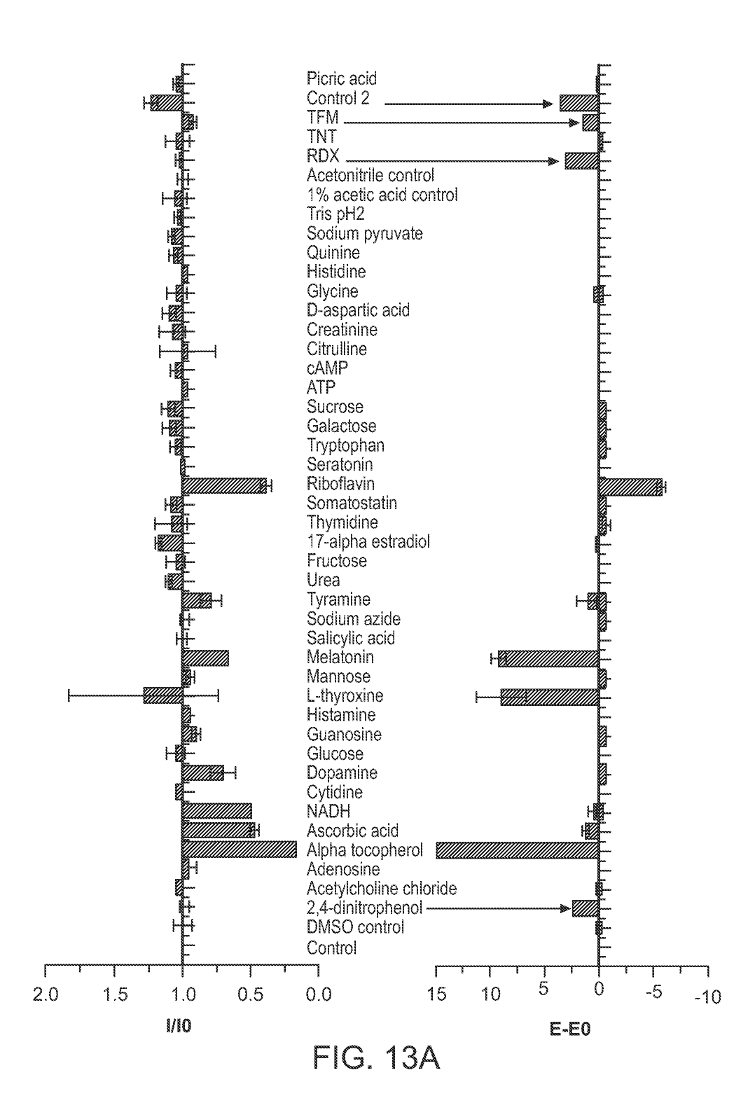

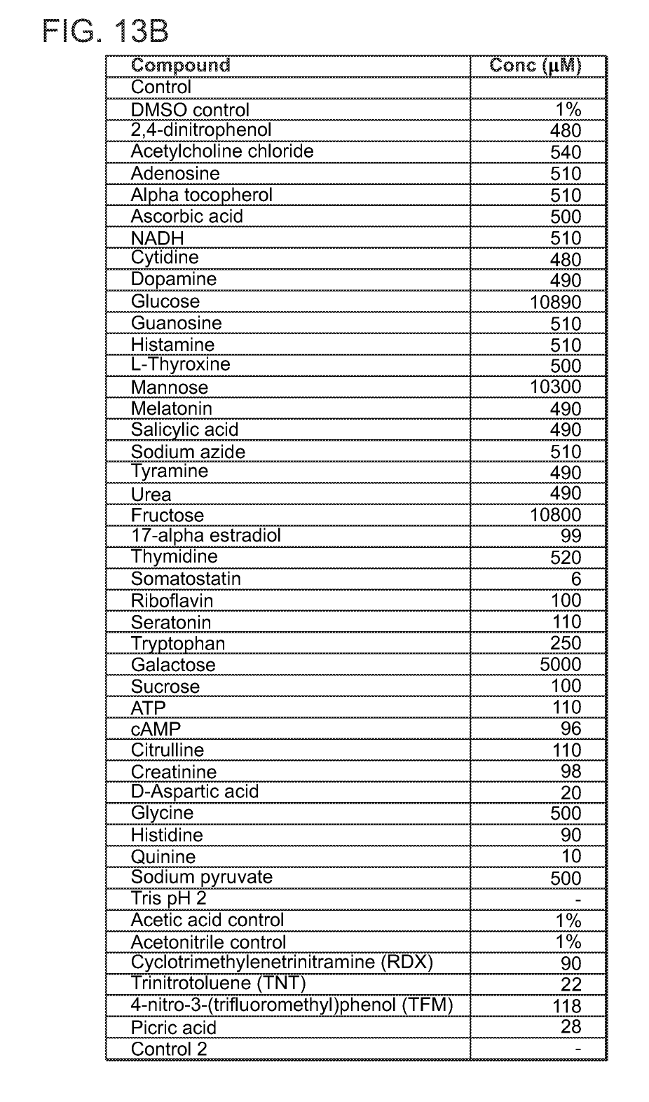

The (7,5) nanotube, encapsulated by bombolitin II, a variant of a bumblebee venom-derived amphiphilic peptide, screened against a library of 42 analytes, exhibits quenching of certain redox-active compounds, as well as wavelength shifts with slight concomitant intensity variation in response to several nitro-group containing compounds, as shown in FIGS. 13A-B. Picric acid, cyclotrimethylenetrinitramine (RDX), 2,4-dinitrophenol, and 4-nitro-3(trifluoromethyl)phenol (TFM) induce spectral shifts without significant signal attenuation. Other shifting analytes induce large intensity diminutions.

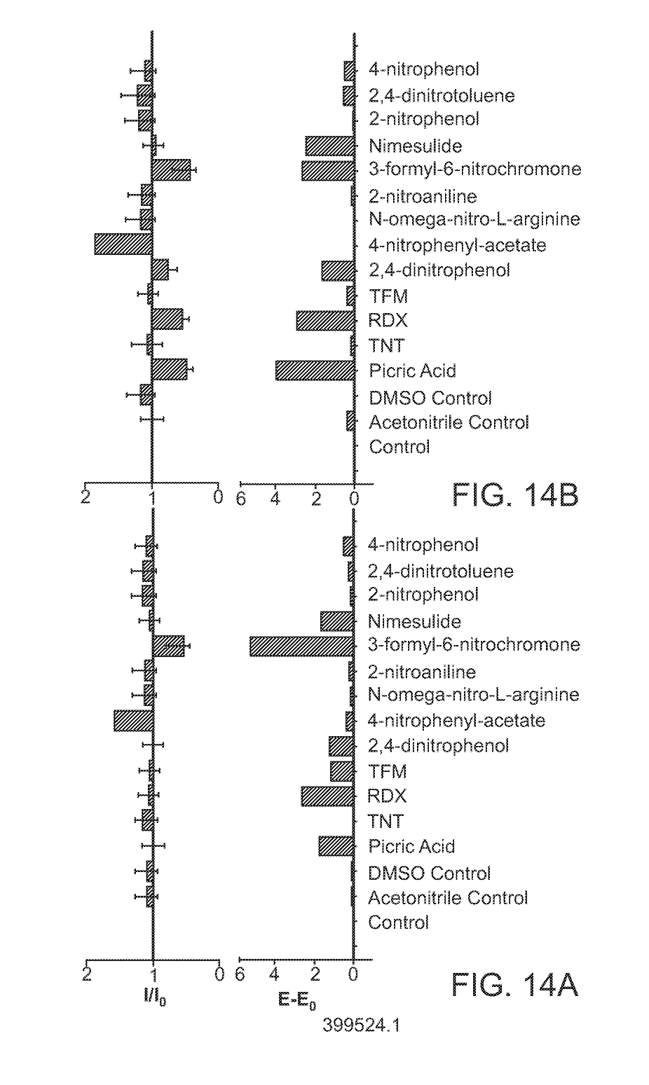

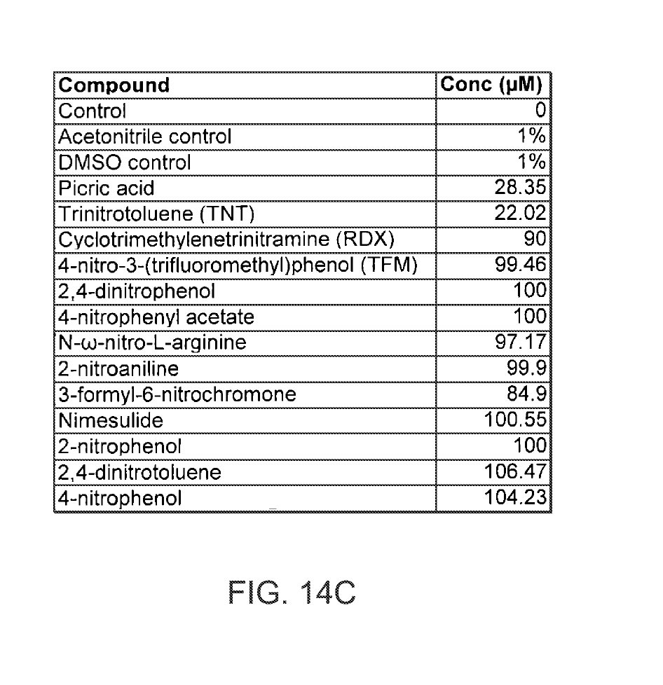

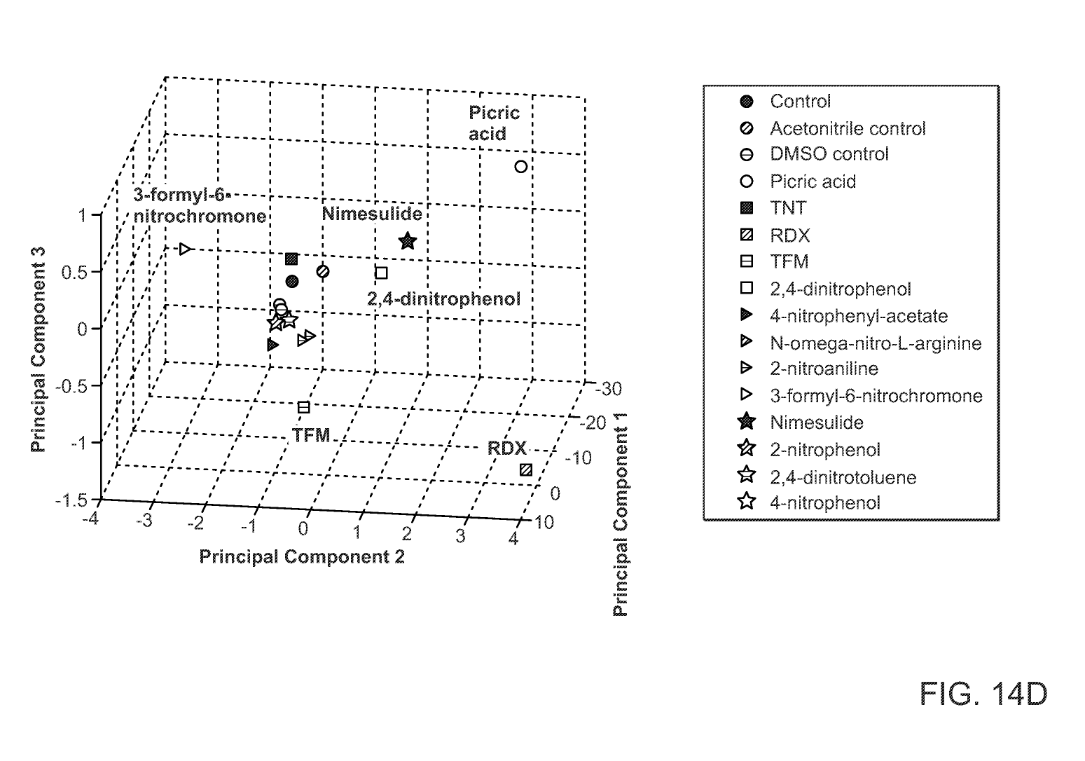

Exposing bombolitin II-SWNT to a diverse set of nitro group compounds (FIG. 14A-B) finds that 6 of 13 such analytes (FIG. 14C) exhibit significant wavelength shifts with little concomitant attenuation, a relatively rare effect which suggests a significant change in the nanotube's dielectric environment. The spectral changes differ among analytes, and different (n,m) nanotube species exhibit individualized detection signatures, where the intensity and wavelength changes vary across SWNT species. This variation is demonstrated here for the (7,5) and (11,3) species, which possess different diameters (0.829 nm vs 1.014 nm), chiral angles (24.5° vs 11.74°), and optical bandgaps (1.211 eV vs 1.036 eV).

The analytes generate differentiable fingerprints via distinct spectral signatures and unique responses of several SWNT (n,m) species in a manner analogous to what was shown for genotoxins. Principal components analysis (PCA) performed on the detection data, collected from eight different SWNT species, confirms unique signatures of the six analytes, denoted by their segregation into separate regions of the plot (FIG. 14D), allowing identification of the analytes by their responses. The analysis was conducted by compiling all eight nanotubes' intensity change and wavelength shifting data for each analyte. The first three principal component scores, which account for a total of 99.5% of the total data variance, are shown. All detected analytes contain ring structures and nitro groups, but few other recognizable structural components or patterns are present in the responding set. Though bombolitin II is a relatively short peptide, it is difficult to predict binding events of such species, which accounts for the need for high-throughput selection methods such as phage display.

In one embodiment, an analyte is detected indirectly via the optical transduction of the secondary structure changes to a polypeptide in solution. The sensor can thus be considered a “chaperone” sensor. The bombolitin class of amphipathic, bee venom-derived peptides, not previously known for nitroaromatic recognition, undergoes a unique sequence-dependent conformational change upon binding, resulting in a specific analyte response involving wavelength shifting of the SWNT emission. The induced wavelength shift permits both the fingerprinting of the analyte via analysis of the response of different SWNT species, as well as the imaging of the solvatochromic shifting of single nanotubes. The imaging of single-nanotube shifts is conducted using a novel split-channel microscope to image solvatochromic events by turning a wavelength shift into an anti-correlated intensity fluctuation which can be monitored spatially and in real-time. In addition to the above mechanism, electronic and steric effects of an adsorbed biopolymer have been shown to create a binding site for selective detection of a nitroaromatic analyte via excitonic quenching on the nanotube sidewall. In this case, the ss(AT)₁₅ oligonucleotide encapsulation of SWNT results in a selective optical sensor for TNT with single-molecule resolution. As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the invention has been particularly shown and described with references to preferred embodiments thereof, it will be understood by those skilled in the art that various changes in form and details may be made therein without departing from the spirit and scope of the invention as defined by the appended claims.

1. A system for infrared spectroscopic imaging, the system comprising:
a light source that illuminates a region of interest of an object to induce a luminescent emission having a range of infrared wavelengths;
an optical separator that spatially separates the emission into a first spectral image and a second spectral image, the first spectral image formed from a shorter wavelength range of light than the second spectral image; and
a detector that detects the first spectral image and the second spectral image.

2. The system of claim 1 wherein the object comprises a carbon nanostructure having a first infrared fluorescent emission and a second infrared fluorescent emission.

3. The system of claim 1 further comprising a data processor connected to the detector, the data processor determining a quantitative characteristic of the object.

4. The system of claim 3 wherein the quantitative characteristic comprises a concentration of an analyte within the object.

5. The system of claim 1 further comprising an optical system that optically couples the object to the detector.

6. The system of claim 1 wherein the optical separator spatially separates a third spectral image having a wavelength range different from the wavelength ranges of the first and second spectral images.

7. The system of claim 1 further comprising a filter that filters at least the first spectral image.

8. The system of claim 1 wherein said optical separator comprises one or more components selected from a microscope, a beam splitter, a dichroic mirror, an edge filter, and a bandpass filter.

9. The system of claim 1 wherein the light source emits light at a wavelength in a range of 400 nm to 1400 nm.

10. The system of claim 1 wherein the detector detects light having a wavelength in a range of 900 nm to 1700 nm.

11. The system of claim 1 further comprising a filter positioned to filter light emitted by the object.

12. The system of claim 1 wherein the optical separator splits the emitted light into at least four separate spectral images of the same region of interest.

13. The system of claim 6 wherein the optical system optically couples a single image of the object to a detecting surface area of the detector such that the optical separator separates the single image into a plurality of spectral images that are detected by a corresponding plurality of separate detecting regions of the detecting surface area.

14. The system of claim 1, wherein the wavelength ranges of the first spectral image and the second spectral image are non-overlapping.

15. The system of claim 1, wherein the wavelength ranges of the first spectral image and the second spectral image are adjacent to one another.

16. The system of claim 1, wherein the wavelength range of the first spectral image and the wavelength range of the second spectral image are within a photoluminescence emission band of the object.

17. The system of claim 1, wherein the light source comprises one or more of a laser light source, a halogen light source, a laser diode or a combination of different wavelength light sources.

18. The system of claim 1, wherein the detector detects the first spectral image and the second spectral image at a rate of 50 frames per second or more.

19. The system of claim 1, further comprises an array comprises one or more defined regions or wells, each containing one or more nanostructures arranged on a substrate.

20. The system of claim 19, wherein the system simultaneously images a plurality of samples in the array.

21. The system of claim 1, further comprising a movable optical head, optically coupled to the light source, optical separator and detector, that is positioned adjacent to the object.

22. The system of claim 21, further comprising a fiber optic connection that optically couples the movable optical head to the light source, optical separator and detector.

23. A method of spectral imaging of a carbon nanostructure comprising:
illuminating a nanomaterial to induce fluorescence emission in an infrared wavelength range;
optically separating the fluorescence emission into a first spectral image and a second spectral image, the first spectral image having a shorter wavelength range of light than the second spectral image; and
detecting the first spectral image and the second spectral image.

24. The method of claim 23 wherein the nanomaterial comprises a carbon nanotube.

25. The method of claim 23 further comprising detecting the first spectral image with a first detector surface region and detecting the second spectral image with a second detector surface region.

26. The method of claim 23 further comprising filtering the infrared fluorescence emission.

27. The method of claim 23 further comprising contacting the nanomaterial with an analyte.

28. The method of claim 23 further comprising analyzing the first spectral image and the second spectral image to determine either a ratio or a difference of said first and second spectral images.

29. The method of claim 23 further comprising analyzing the first spectral image and the second spectral image to determine a presence, location, amount, or concentration of an analyte.

30. The method of claim 23 wherein a third spectral image is formed, the third spectral image having a wavelength range different from the wavelength ranges for the first and second spectral images.

31. The method of claim 23 wherein the steps of illuminating, optically separating, and detecting are repeated at least once, and a series of first and second spectral images is formed.

32. The method of claim 31 further comprising analyzing the series of first spectral images and the series of second spectral images to determine a change of concentration of an analyte within the sample.

33. The method of claim 29 wherein the analyte is selected from the group consisting of small organic molecules, polymers, proteins, metabolites, and pharmaceutical agents.

34. The method of claim 29 wherein the object comprises one or more biological cells.

35. The method of claim 29 wherein a single-walled carbon nanotube (SWNT) is imaged.

36. The method of claim 23 wherein the SWNT is derivatized with a small organic molecule, a polymer, a protein, a nucleic acid, or an antibody.

37. The method of claim 60 wherein the fluorescence emission intensity or wavelength is changed in the presence of the analyte.

38. The method of claim 23, further comprising illuminating the nanomaterial using one or more of a laser light source, a halogen light source, a laser diode and a combination of different wavelength light sources.

39. The method of claim 23, further comprising:
illuminating a plurality of nanostructures, each corresponding to a different emission band, to induce a plurality of fluorescence emissions; optically separating each emission into a first spectral image and a second spectral image; and simultaneously detecting the first and second spectral images corresponding to the plurality of fluorescence emissions.

40. The method of claim 23, further comprising:
providing the nanomaterial within a biologic fluid; and
analyzing the first spectral image and the second spectral image to determine a presence, location, amount, or concentration of an analyte within the biologic fluid.
